(19) United States
(12) Patent Application Publication
(10) Pub. No.: US 2010/0184575 A1
(43) Pub. Date: Jul. 22, 2010

(54) METHODS AND SYSTEMS FOR MONITORING THE OPERATION OF A ROBOTIC ACTUATOR

(75) Inventors: Jennifer WILLIAMS, Malta, NY (US); Clay C. COOPER, Clifton Park, NY (US); Michael F. BOWMAN, Ballston Lake, NY (US); John RINALDI, Wauwatosa, WI (US)

Correspondence Address: HESLIN ROTHENBERG FARLEY & MESITI PC, 5 COLUMBIA CIRCLE, ALBANY, NY, 12203, US

(73) Assignee: APPLIED ROBOTICS, INC., Glenville, NY (US)

(21) Appl. No.: 12/691,261

(22) Filed: Jan. 21, 2010

Related U.S. Application Data
(60) Provisional application No. 61/146,214, filed on Jan. 21, 2009.

(51) Int. Cl. B23Q 3/155

(52) U.S. Cl. 483/13

(57) ABSTRACT

A robotic tool changer and systems and methods for controlling the operation of a robotic tool changer are provided. The tool changer, methods, and systems include a robot-side component mountable to a robot arm end interface; a tool-side component adapted to engage a tool; a first slave module associated with the robot-side component and adapted to communicate with a first master module; and a second master module associated with the robot-side component and adapted to communicate with a second slave module associated with the tool. The second slave module may include a temporary power supply, for example, a battery or a capacitor, for instance, a super capacitor. Aspects of the invention are advantageous for performing high-speed robotic connections and disconnections, and for providing tool and tool changer performance information gathering.

### CROSS-REFERENCE TO RELATED APPLICATION

This application claims priority from pending U.S. Provisional Patent Application 61/146,214, filed on Jan. 21, 2009, the disclosure of which is included by reference herein in its entirety.

### BACKGROUND OF THE INVENTION

1. Field of the Invention

The present invention generally relates to robotic arm end actuators and their control. More particularly, the present invention relates to methods and systems for operating and communicating to and from tools to optimize tool performance.

2. Description of Related Art

In the art of automation control, for example, the control of robots and robot-like manipulators, the robot, the robotic tool changer, and the tools handled by the robot are typically controlled by a controller, for example, a programmable logic controller (PLC) or computer. The communication between the controller and these components is typically made via a cable or bus, for example, a controller-area network (CAN) bus. The communications bus is adapated to allow communication between the controller and the tool changer and the tools to provide the desired tools and tool operation.

As is common in the art, the communication between a controller and a tool changer is typically comprises a “master-slave” relationship, whereby the controller is the “master” and tool changer and tools are the “slaves.” In the present art of automation control, the accepted communications protocol for typical master-slave communications is the DeviceNet protocol. As is known in the art, DeviceNet is a communications networking protocol used in the automation industry to interconnect control devices for the communication of data and control signals. DeviceNet is supported by the independent, international Open-source DeviceNet Vendors Association (ODVA).

However, though the DeviceNet protocol is a generally accepted communications protocol in the automation industry, DeviceNet and related protocols are characterized by disadvantages that may hamper the operation and efficiency of tool changers and tools so controlled. For example, the present applicants found such communications protocols unacceptable for the high-speed connections and disconnections and performance information gathering requirements typically encountered in this competitive industry. Moreover, the applicants also found such protocols limited in their ability to monitor, collect, and report certain operating parameters of tool changers and tools. Accordingly, aspects of the present invention were developed to overcome these disadvantages.

### SUMMARY OF THE INVENTION

A robotic tool changer and systems and methods for controlling the operation of a robotic tool changer are provided that are advantageous for performing high-speed robotic connections and for gathering tool and tool changer performance information.

One aspect of the invention that addresses or overcomes the disadvantages of the prior art is a tool changer including or comprising: a robot-side component mountable to a robot arm end interface; a tool-side component adapted to engage a tool; a first slave module associated with the robot-side component and adapted to communicate with a first master module; and a second master module associated with the robot-side component and adapted to communicate with a second slave module associated with a tool. In one aspect, the first master module communicates with the first slave module by employing a first network protocol and the second master module communicates with the second slave module employing a second network protocol, for example, a common network protocol, such as the DeviceNet network protocol. In another aspect, the second slave module further comprises a power supply, for example, a rechargeable temporary power supply, such as, a super capacitor.

Another aspect of the invention is a system for controlling the operation of a robotic tool changer, the system including or comprising: a controller having a first master module; a robot having an arm end interface; a tool changer having a robot-side component mounted to the arm end interface and a tool-side component adapted to engage a tool; a first slave module associated with the robot-side component, the first slave module adapted to communicate with the first master module; a second master module associated with the robot-side component; and a second slave module associated with the tool-side component and adapted to communicate with the second master module. In one aspect, the system further comprises a robot-side module housing mounted to the robot-side component, the robot-side module housing containing the first slave module and the second master module. In another aspect, the system further comprises a tool-side module housing mounted to the tool-side component, the tool-side module housing containing the second slave module. In another aspect, the second slave module of the tool changer further comprises a power supply, such as, a super capacitor. In another aspect, the second master module may be adapted to communicate with an external receiver, for example, to an internet-enabled server. The second master module may communicate with the external receiver employing a network protocol, different from the DeviceNet protocol, for example, via the Ethernet protocol or Ethernet I/P protocol. The second master module may transmit tool changer operating parameters or tool operating parameters to, for example, an internet web page.

A further aspect of the invention is a method for monitoring the operation of a robot tool changer mounted to a robot, the tool changer having a robot-side component and a tool-side component, and the tool changer communicating to a controller via a network communications bus (for example, a CAN), the method including or comprising detecting an operational parameter of the tool changer or tool; transmitting the operational parameter to an external receiver (for example, to a receiver over the Internet) over a communications bus (for example, an Ethernet cable), different from the control network communications bus (for example, a CAN). The operational parameter of the tool changer may be input status, output status, power status, number of couplings, number of coupling/uncoupling cycles, coupling time, uncoupling time.

Another aspect of the invention is a system for monitoring the operation of a robot tool changer mounted to a robot, the tool changer having a robot-side component and a tool-side component, and the tool changer communicating to a controller via a network communications bus (for example, a CAN), the system including or comprising: a detector adapted to detect an operational parameter of the tool changer or a tool; a transmitter adapted to transmit the operational parameter; and a communications bus (for example, an Ethernet cable), different from the control network communications bus (for example, a CAN), for transmitting the operational parameter to a receiver (for example, to a receiver over the Internet).

A still further aspect of the invention is a method for controlling the operation of a robotic tool changer, the tool changer operated under the guidance of a controller having a master module and the tool changer having a robot-side component mounted to a robotic arm end and a tool-side component mounted to a tool, the robot-side component further having a slave module in communication with the controller master module and the robot-side component further having a master module in communication with a slave module associated with the tool, the method including or comprising: communicating a first control signal from the controller master module to the robot-side component slave module; communicating a second control signal, corresponding to the first control signal, from the robot-side component slave module to the robot-side component master module; and communicating a third control signal, corresponding to the second control signal, from the robot-side component master module to the slave module associated with the tool. In one aspect, the method may further comprise, prior to communication the first control signal, engaging the robot-side component with the tool-side component. In another aspect, the method may further comprise energizing at least one device on the tool side component prior to engaging the robot-side component with the tool-side component, for example, by providing a power supply, such as, a super capacitor, coupled to the at least one device to the tool-side component.

A further aspect of the invention is a method for reducing the connection time between a robot-side component and the tool-side component of a robot tool changer, the method including or comprising: energizing at least one device adapted to store at least some information about the tool-side component; coupling the robot-side component with the tool-side component; and communicating at least some date from the energized device to the robot side component. In one aspect, energizing may comprise providing a power supply, for example, a rechargeable power supply, such as, a capacitor, coupled to the at least one device to the tool-side component.

These and other aspects, features, and advantages of this invention will become apparent from the following detailed description of the various aspects of the invention taken in conjunction with the accompanying drawings

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic diagram of a system for controlling the operation of a robotic actuator according to the prior art.

FIG. 2 is a schematic diagram of system for controlling the operation of a robotic actuator according to one aspect of the present invention.

FIG. 3A is a schematic perspective view of an actuator, for example, a tool changer, having a subcontroller according to one aspect of the invention.

FIG. 3B is a schematic perspective view of another actuator, for example, a tool changer, having a subcontroller according to another aspect of the invention.

FIG. 4 is a perspective view of the subcontroller or robot-side module assembly shown in FIG. 3B.

FIG. 5 is an exploded perspective view of the subcontroller or robot-side module assembly shown in FIG. 4.

FIG. 6 is a perspective view of the tool-side module assembly shown in FIG. 3B.

FIG. 7 is an exploded perspective view of the tool-side module assembly shown in FIG. 6.

### DETAILED DESCRIPTION

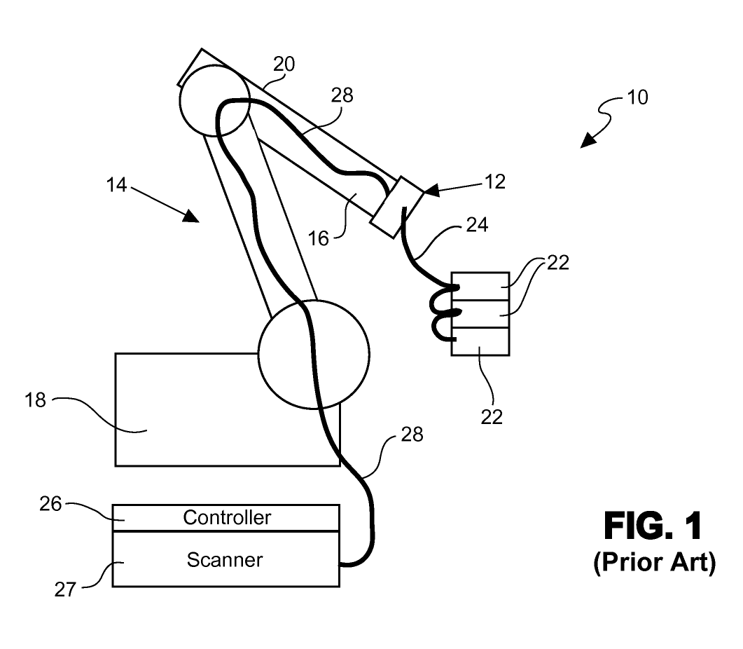

FIG. 1 is a schematic diagram of a system 10 for controlling the operation of a robotic actuator 12, for example, a tool changer, according to the prior art. As shown in FIG. 1, system 10 includes a robot 14 having an arm end 16 to which actuator 12 is typically mounted. As is typical, robot 14 includes a base 18 and an articulating arm 20 having arm end 16. As is typical of the prior art, actuator 12 is designed to engage and communicate with a plurality of tools 22, for example, manipulators, welders, and the like, which can be positioned by robot 14. Though the mechanical engagement of actuator 12 with tools 22 may be effected by a broad array of mechanical couplings, the electrical communication, for example, data and/or control signals, between actuator 12 and each of tools 22 is represented by bus 24.

According to the prior art, the operation of the robot 14, of the actuator 12, and of the tools 22 is typically controlled by a controller 26. Controller 26, for example, a programmable logic controller (PLC) or computer, typically communicates with actuator 12 via a controller cable, wire, or bus 28. Bus 28 is typically controller-area network (CAN) bus, that is, is a network communications bus adapated to allow communication between controller 26 and actuator 12.

As is common in the art, the communication between controller 26 and actuator 12 typically comprises a “master-slave” relationship, whereby controller 26 is the “master” and actuator 12 and tools 22 are the “slaves.” For example, in the master-slave communication relationship, the master device typically has unidirectional control over the operation of the slave devices. The accepted communications protocol for a typical master-slave communications is the DeviceNet protocol. As is known in the art, DeviceNet is a communications networking protocol used in the automation industry to interconnect control devices for the communion of data and control signals. DeviceNet is supported by the international Open-source DeviceNet Vendors Association (ODVA) [having a website http://www.odva.org, which is incorporated by reference herein]. For example, as shown in FIG. 1, controller 26 may typically include a DeviceNet master module 27, actuator 12, for example, the robot side of a coupling device, and tools 22 may each typically include a DeviceNet slave module (not shown).

However, though the DeviceNet protocol is a generally accepted communications protocol in the automation industry, DeviceNet and related protocols are characterized by disadvantages that may hamper the operation and efficiency of the actuator 12 and tools 22 so controlled. For example, the present applicants found such communications protocols unacceptable for the high-speed connections and disconnections and performance information gathering requirements typically encountered in this competitive industry. Moreover, the applicants also found such protocols limited in their ability to monitor, collect, and report certain operating parameters of actuator 12 and/or tools 22. Accordingly, aspects of the present invention were developed to overcome these disadvantages.

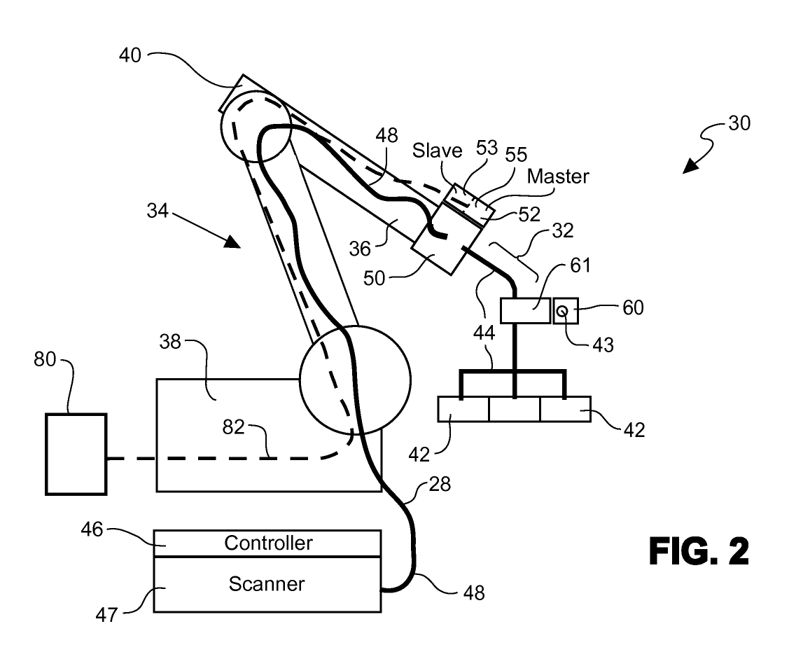

FIG. 2 is a schematic diagram of system 30 for controlling the operation of a robotic actuator 32, for example, a tool changer, according to one aspect of the present invention. For example, actuator 32 may be CXC™ tool changer, an Omega™ tool changer, or Sigma™ tool changer provided by Applied Robotics Inc. of Glenville, N.Y., though other tool changers may be used with aspects of the invention. As shown in FIG. 2, system 30 includes a robot 34 having an arm end 36 to which actuator 32 is typically mounted. Actuator 32 typically includes a robot-side component 50 and a tool-side component 61. Robot 34 may be any conventional robotic device, for example, a GE FANUC M-900 robot, though other types of robots may be used according to aspects of the invention. Robot 34 includes a base 38 and an articulating arm 40 having arm end 36. As is typical of the prior art, actuator 32 is designed to engage and communicate with a plurality of tools 42, for example, manipulators, welders, and the like, which can be positioned by robot 34. According to aspects of the invention, though the mechanical engagement of actuator 32 with tools 42 may be effected by a broad array of mechanical couplings, the electrical communication, for example, data and/or control signals, between actuator 32 and each of tools 42 is represented by bus 44.

In a manner similar to prior art system 10 shown in FIG. 1, the operation of the robot 34, of the actuator 32, and of the tools 42 may typically be controlled by a controller 46. Controller 46, for example, a programmable logic controller (PLC) or computer, typically communicates with actuator 32 via a controller cable, wire, or bus 48, for example, a CAN bus. According to aspects of the present invention, the communication between controller 46 and actuator 32 may comprise a “master-slave” relationship, as discussed above, whereby controller 46 includes a master module 47, for example, a DeviceNet master module, and the robot-side component or module 52 of actuator 32 includes a slave module 53, for example, a DeviceNet slave module. However, according to aspects of the present invention, unlike the prior art, system 30 includes a robot-side module 52 having a master module 55, for example, another DeviceNet master module, which may also be associated with master module 47 of controller 46, and a tool-side module 60 having a slave module (not shown), for example, another DeviceNet slave module, that may communicate with slave modules (not shown) associated with tools 42, for example, DeviceNet slave modules. For example, according to aspects of the invention, a master-slave network communication relationship is provided between controller 46 and slave module 53 of robot-side module 52, and a master-slave network communications relationship is provided between master module 55 of robot-side module 52 of robot side component 50 and a slave module in tool-side module 60 of tool-side component 61, which may be mounted to a tool 42. That is, in one aspect of the invention, a DeviceNet subnetwork may be provided between a tool coupler robot side and a tool coupler tool side.

In one aspect of the invention, system 30 may operate with a network connection from master module 47 to a slave module in robot-side component 50 via bus 48 without the knowledge of or interfacing with the master-slave network between tool-side module 52 and tools 42. For example, a master-slave network relationship may be provided between DeviceNet master module 47 and DeviceNet slave module in robot-side component 50 of actuator 32 with little or no influence or communication with the network associated with the master module 55 in robot-side module 52 of robot-side component 50 of actuator 32 and the tool 42 slave modules.

According to aspects of the invention, the applicants have found that this mode of option with a subnetwork communications system provides improved connection speeds between the tool changer 32 and the tool 42.

In one aspect of the invention, communication between the master module in tool-side component 52 in actuator or tool changer 32 and the slave modules in tools 42 is facilitated by one or more modules or subcontrollers 52 mounted to robot-side component 50 and module 60 mounted to tool-side component 61, for example, robot-side module 52 may include an electronic controller board having embedded software, associated with actuator 32. Module 60 may also function as a slave module to the master module 55 in tool-side module 52 of tool-side component 50. Modules 52 and 60 may be mounted in components 50 or 61 of actuator 32 or mounted to components 50 or 61, for example, mounted to the housing of the tool-side component of tool changer 32. According to aspects of the invention, modules 52 includes a slave module 53 that communicates with the master module 47 in controller 46 and includes a master module 55 that communicates with a slave modules (not shown) in tool-side component 60, and to one or more tools 42.

In one aspect of the invention, tool-side module 60 of tool-side component 61 may include one or more power supplies or energy storage devices 43. Power supplies 43 may be provided to provide at least some electrical power to module 60 to power one or more devices or facilitate or expedite subsequent communications, for example, handshaking, between actuator 32 and tool 42. In one aspect, power supply 43 may provide temporary electrical power to tool 42, for example, in one aspect, power supply 43 may be one or more batteries, for example, a rechargeable battery, or one or more capacitors, for instance, one or more “super capacitors” as will be described below.

According to one aspect, power supply 43 may be a chargeable or rechargeable device, for example, that may be charged or recharged when actuator 32, for example, the robot-side component 50, engages a tool, for example, engages tool-side component 61. For instance, when engaged, power can be provided to tool-side component 61, for example, from an external source. In addition, according to aspects of the invention, when robot-side component 50 of actuator 32 disengages tool-side side component 61 having tool 42, for example, when tool 42 is in a tool stand, power supply 43 can provide at least some power to tool 42, for example, in what is referred to as a “sleep state,” for instance, for a limited time, to power electrical devices on tool 42. For example, power supply 43 may power a volatile memory module or a processor performing a desired function, for example, monitoring when robot-side component 50 re-engages tool-side component 61 or monitoring when electrical power is restored to tool 42. In one aspect, when power supply 43 is a capacitor, at least initially, the capacitor may require two or more engagement/disengagement cycles or one long engagement to fully charge the capacitor. The capacitor may be sufficiently charged and provide sufficient current to energize devices on tool-side module 60 for at least 5 seconds, but typically at least 20 seconds, or even 30 seconds, for example, to provide sufficient time to power the devices of tool-side module 60 between disengagement and re-engagement with robot-side module 52.

As noted above, in one aspect, power supply 43 may comprise a “super capacitor,” for example, a super capacitor marketed under the name Aerogel by Cooper/Bussman, for example, model number KR-5R5V474-R rated at 0.47 farads (F) and 5.5 volts (V), though other “super capacitors” may be used.

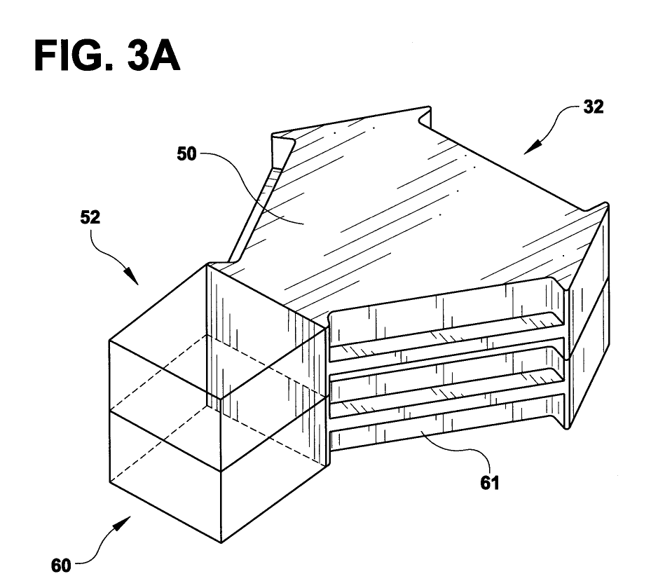

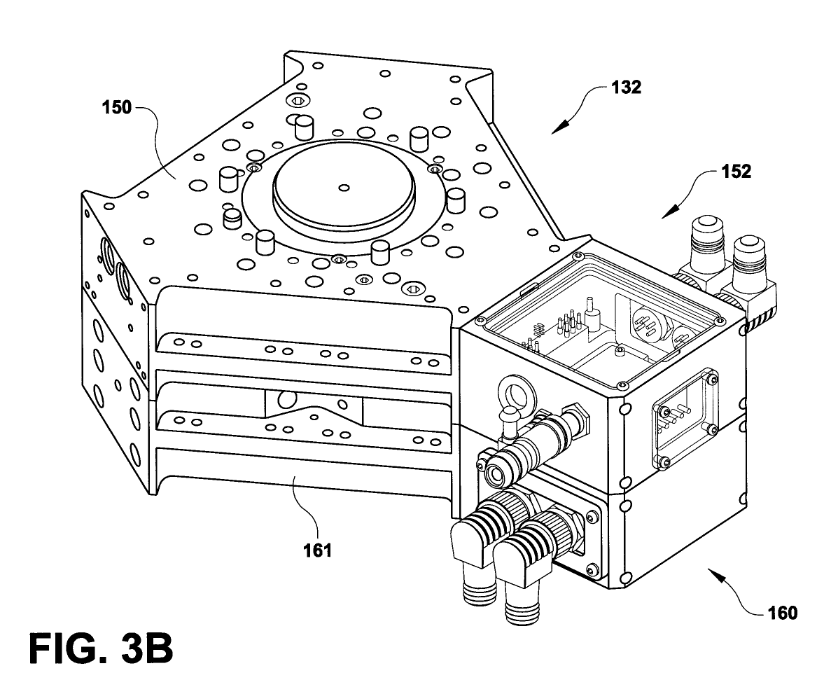

FIG. 3A is a schematic perspective view of actuator 32, for example, a tool changer, shown in FIG. 2 having a robot-side module or subcontroller 52 and a tool-side module or subcontroller 60 according to one aspect of the invention. Though the aspect of the invention shown in FIG. 3A represents subcontrollers 52 and 60 mounted to a Sigma tool changer provided by Applied Robotics Inc., any actuator or tool changer may be used with subcontrollers 52 and 60 according to aspects of the invention. As shown in FIG. 3A, tool changer 32 includes a “robot-side” component 50 and a “tool-side” component 61. As is known in the art, robot-side component 50 is adapted to engage an arm end of a robot, for example, arm end 36 of robot 34 shown in FIG. 2, and tool-side component 61 is adapted to engage a tool, for example, one of tools 42 shown in FIG. 2. In addition, according to aspects of the invention, subcontrollers 52 and 60 also communicate electronically, as will be discussed below.

FIG. 3B is a schematic perspective view of another actuator 132, that may be similar to tool changer 32 shown in FIG. 3A. As shown, actuator 132 includes a robot-side module or subcontroller 152 and a tool-side module or subcontroller 160 according to another aspect of the invention. Though the aspect of the invention shown in FIG. 3B represents subcontrollers 152 and 160 mounted to a Sigma tool changer provided by Applied Robotics Inc., any actuator or tool changer may be used with subcontrollers 152 and 160 according to aspects of the invention. As shown in FIG. 3B, tool changer 132 includes a “robot-side” component 150 and a “tool-side” component 161. As is known in the art, robot-side component 150 is adapted to engage an arm end of a robot, for example, arm end 36 of robot 34 shown in FIG. 2, and tool-side component 161 is adapted to engage a tool, for example, one of tools 42 shown in FIG. 2. In addition, according to aspects of the invention, subcontrollers 152 and 160 also communicate electronically, as will be discussed below.

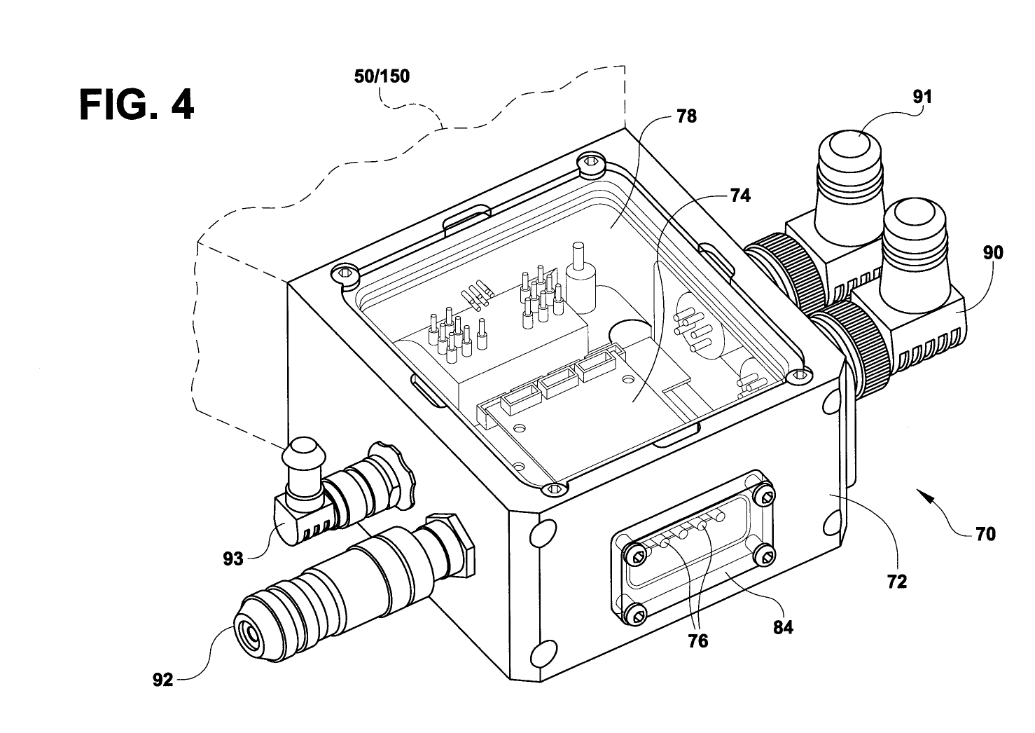

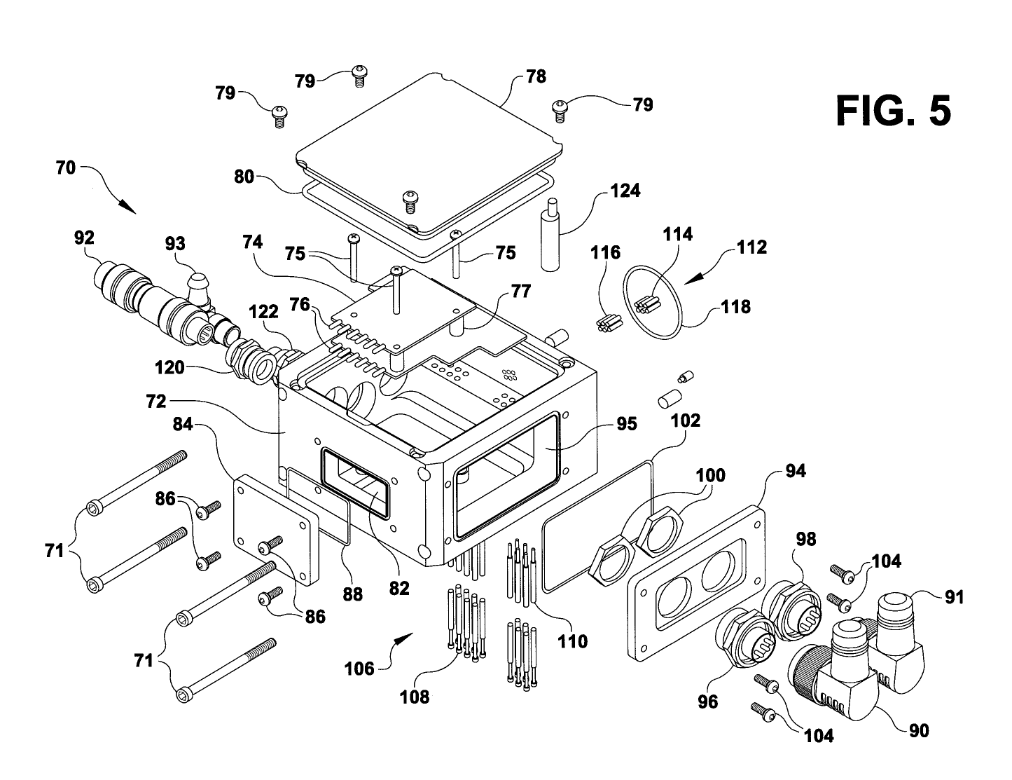

FIG. 4 is a perspective view of a robot-side module or subcontroller assembly 70 that can be mounted to actuator 32 shown in FIGS. 2, 3A, and 3B, for example, to the robot-side component 50 or 150, as partially shown in phantom in FIG. 4. FIG. 5 is an exploded perspective view of robot-side module or subcontroller assembly 70 shown in FIG. 4. As shown in FIGS. 4 and 5, subcontroller assembly 70 includes a housing 72 adapted to mount to actuator 32, for example, by means of mechanical fasteners 71, for example, stainless steel socket head cap screws, and a plurality of electrical, mechanical, hydraulic, and/or pneumatic connectors mounted to housing 72. Housing 72 may be metallic or non-metallic, but is typically made of plastic, for example, from a polyoxymethylene (POM) plastic, such as, Dupont's Delrin® POM, or its equivalent. According to aspects of the invention, housing 72 contains one or more circuit boards 74 adapted to detect, store, and transmit control and data signals and provide output, for example, in the form of an illuminated display, for example, via LEDs 76. As shown in FIG. 5, circuit board 74 may include two or more circuit boards separated by spacers 77, for example, plastic spacers, such as, spacers made from polyamide plastic, such as, Dupont's Nylon® 101 polyamide, or its equivalent. Circuit board 74 may be mounted in housing 72 by means of mechanical fasteners 75, such as, alloy steel socket head cap screws. In one aspect, the one or more circuit boards 74 in subcontroller assembly 70 may be adapted to use one or more different software protocols, for example, DeviceNet protocol and one or more Ethernet protocols, for instance, Ethernet and/or Ethernet I/P.

Housing 72 may also include a removable cover 78 mounted to housing 72 by a plurality of fasteners 79, for example, stainless steel button head cap screws. Cover 78 may be made of a plastic, for example, a polycarbonate, such as, a transparent, abrasion-resistant polycarbonate, or its equivalent. A gasket or an O-ring seal 81, for example, a rubber O-ring, may be provided about cover 78 to substantially isolate the inside of housing 72 from the external environment. Housing 72 may also include one or more openings 82, for example, for viewing LEDs 76. Opening 82 may be provided with a cover 84 mounted over opening 82 and fastened by means of a plurality of fasteners 86, for example, alloy steel pan head thread-forming screws. Cover 84 may also be made of a plastic, for example, a polycarbonate, such as, a transparent, abrasion-resistant polycarbonate, or its equivalent. A gasket or an O-ring seal 88, for example, a rubber O-ring, may be provided about cover 84.

Subcontroller 70 may include a plurality electrical connections, for example, be connectorized, as needed. Housing 72 may include cable connectors 90, 91, 92, and 93. For example, connector 90 may be a Turck wkm 46-m cable connector and connector 91 may be a Turck wkm 55-m cable connector, or their equivalents. Connectors 90 and 91 may typically be adapted to introduce DeviceNet control and/or data signals from a robot (for example, from controller 46 and scanner 47 along bus 48) to subcontroller 70 and auxiliary power signals (for example, from controller 46) to subcontroller 70, respectively.

As shown in FIG. 5, connectors 90 and 91 may be mounted to housing 72 by means of mounting plate 94 and connector 96, connector 98, and locknuts 100. Mounting plate 94 may be made of a plastic, for example, a POM plastic, such as, Dupont's Delrin® POM, or its equivalent. Connector 96 may be a multi-pin connector, for example, a male, 4-pin RSFL 46 connector, or its equivalent. Connector 98 may also be a multi-pin connector, for example, a 5-pin DeviceNet RSF 57 connector, or its equivalent. Mounting plate 94 may typically be mounted over opening 95 in housing 72 by means of a plurality of fasteners 104, such as, alloy steel pan head thread-forming screws. A gasket or an O-ring seal 102, for example, a rubber O-ring, may be provided about mounting plate 94.

Connector 92 may be a Binder 99-3729-810-04 cable connector, or its equivalent, and connector 93 may be a Turck WS 4.5T-M cable connector, or its equivalent. Connectors 92 and 93 may typically be mounted to housing 72 by means of connector receptacles 120 and 122, respectively. Receptacle 120 may be an Ethernet receptacle, for example, an M12 Ethernet female, rear-mount, 4-socket, D-coded receptacle, or its equivalent. Receptacle 122 may be a Eurofast receptacle, for example, a Eurofast female, rear-mount, 5-socket, D-coded receptacle, or its equivalent.

Connector 92 may typically be adapted to interface subcontroller 70 with a network, for example, an Ethernet network, for instance, networked with controller 46 or with external receiver 80 (see FIG. 2). It will be understood by those of skill in the art that the type of network and the network configuration used with subcontroller 70 may vary broadly, for example, depending upon the type of robot used, the type of application, for example, the type of manufacturing, the wiring, and the network hardware and software, among other things. Accordingly, it will be understood that the type and attributes of connector 92 may also vary.

For example, when the one or more robots used are not compatible with network communication, for example, due to the age of the robots, the one or more robots and their operation may be monitored by a PLC controller. The PLC controller (for example, as indicated by external receiver 80 in FIG. 2) may be coupled to a network, and subcontroller 70 may interface with the PLC controller via connector 92, for example, over cable 82 (in FIG. 2). Subcontroller 70 may interface directly with the PLC and not interface with controller 46, or subcontroller 70 may interface with the PLC via controller 46. In another example, the system 30 may interface with an Ethernet hub or switch associated with each cell in which each robot resides. In this configuration, each subcontroller 70 associated with each robot may interface with the cell hub or switch. For example, the hub or switch may comprise one or more RJ45 Ethernet connectors that link the cell and its subcontroller 70 to a main Ethernet network. As a further example, controller 46 may interface with an Ethernet network where connector 92 from subcontroller 70 may communicate with controller 46 over cable 48 or 82 and then to the network. Other network configurations and communications that may be used for aspects of the invention will be apparent to those of skill in the art.

With respect to FIGS. 4 and 5, connector 93 may typically be adapted to interface subcontroller 70 with a valve on the tool changer. For example, there may be a plurality, for example, 3 or more, electrical signals associated with connector 93. For instance, there may be 2 or more outputs and a common output (for example, a “V aux-”) from circuit board 74. According to one aspect, the signals output from connector 93 may comprise “couple” and “uncouple” signals directed to a valve module of the tool changer. For example, the “couple” and “uncouple” outputs from board 74 that are transmitted through connector 93 may comprise signals that activate or deactivate a solenoid valve that drives the tool changer mechanism (for example, one or more cams), for instance, by means of a pneumatic pressure.

As shown most clearly in FIG. 5, subcontroller 70 may also include a plurality of spring pin assemblies 106 adapted to provide robot side to tool side signal exchange. Spring pin assemblies 106 include spring pin probes 108 and spring pin receptacles 110 adapted to receive spring pin probes 108. As also shown in FIG. 5, subcontroller 70 may include at least one second set of spring pin assemblies 112 having spring pin probes 114 and spring pin receptacles 116 adapted to receive spring pin probes 114. Spring pin assemblies 112 may be adapted to provide tool changer cam position sensor signals (for example, to uncouple or to couple the tool changer). At least one of spring pin assembly 106 and 112 may include a gasket or O-ring seal 118 about its interface with housing 72.

Subcontroller 70 may also include one or more proximity switches 124, for example, a chrome stainless steel proximity switch provided by Balluff and having 1.5 mm detection distance. Proximity switch 124 may be provided to sense tool side module presence, for example, as a “safety” switch.

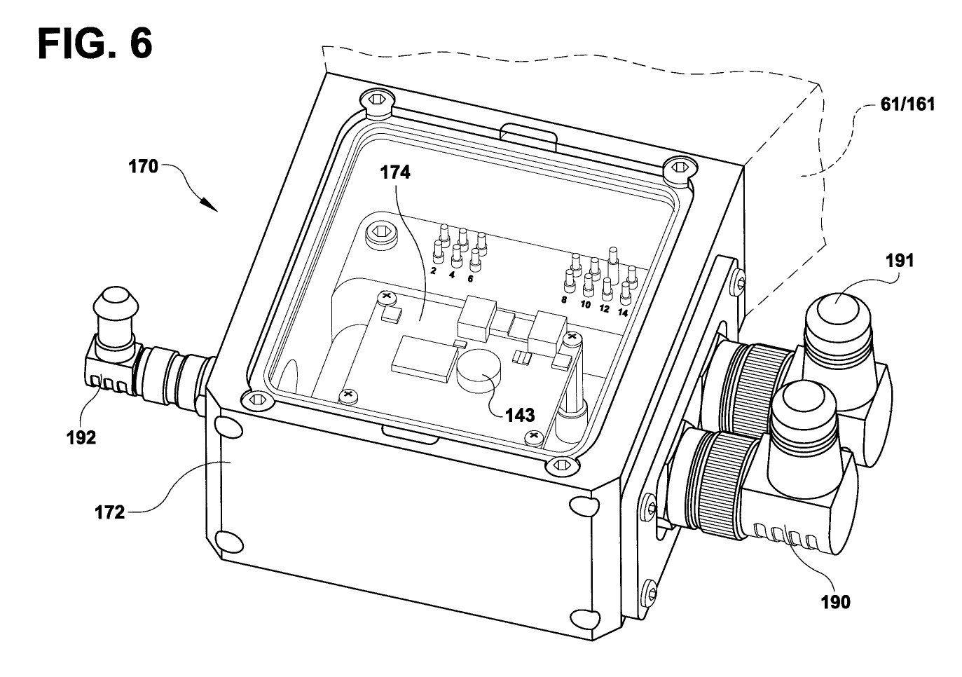

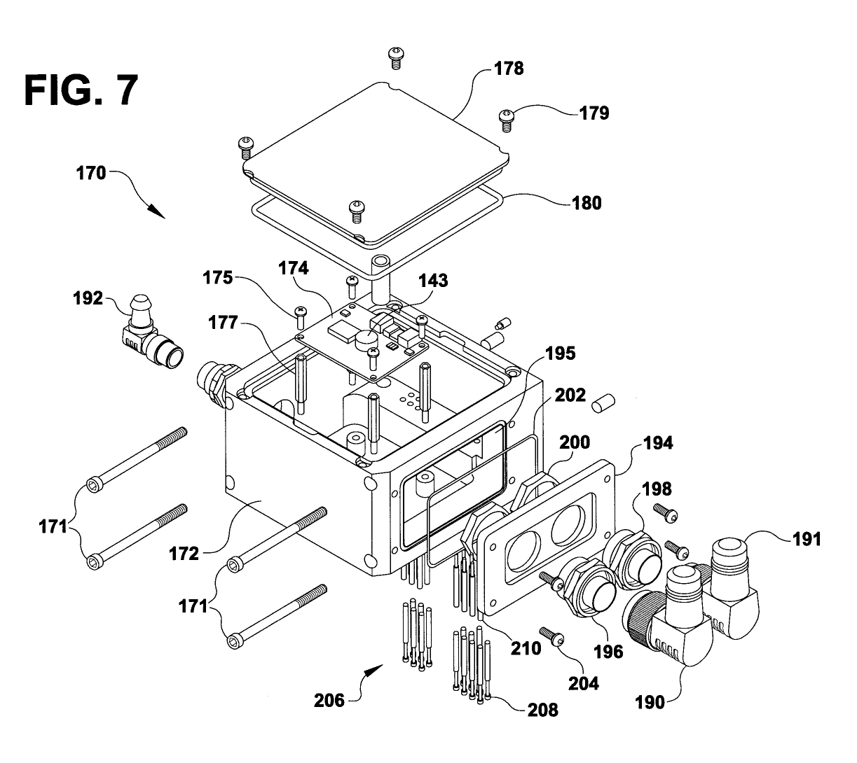

FIG. 6 is a perspective view of a tool-side module or subcontroller assembly 170 that can be mounted to actuator 32 shown in FIGS. 2, 3A, and 3B, for example, to the tool-side component 61 or 161, as partially shown in phantom in FIG. 6. FIG. 7 is an exploded perspective view of tool-side module or subcontroller assembly 170 shown in FIG. 6. As shown in FIGS. 6 and 7, subcontroller assembly 170 includes a housing 172 adapted to mount to actuator 32, for example, by means of mechanical fasteners 171, for example, stainless steel socket head cap screws, and a plurality of electrical, mechanical, hydraulic, and/or pneumatic connectors mounted to housing 172. Housing 172 may be metallic or non-metallic, but is typically made of plastic, for example, from a polyoxymethylene (POM) plastic, such as, Dupont's Delrin® POM, or its equivalent. According to aspects of the invention, housing 172 contains one or more circuit boards 174 adapted to detect, store, and transmit control and data signals and provide output. Circuit board 174 may include two or more circuit boards separated by spacers, for example, plastic spacers, such as, spacers made from polyamide plastic, such as, Dupont's Nylon® 101 polyamide, or its equivalent. Circuit board 174 may be mounted in housing 172 by means of mechanical fasteners 175, such as, Nylon plastic Philips pan-head screws. As shown in FIG. 7, circuit board 174 may be mounted to housing 172 by means of a plurality of cylindrical posts 177, for example, hexagonal, brass, nickel-plated posts. In one aspect, the one or more circuit boards 174 in subcontroller assembly 170 may be adapted to use one or more different software protocols, for example, DeviceNet protocol and one or more Ethernet protocols, for instance, Ethernet and/or Ethernet I/P.

Housing 172 may also include a removable cover 178 mounted to housing 172 by a plurality of fasteners 179, for example, stainless steel button head cap screws. Cover 178 may be made of a plastic, for example, a polycarbonate, such as, a transparent, abrasion-resistant polycarbonate, or its equivalent. A gasket or an O-ring seal 181, for example, a rubber O-ring, may be provided about cover 178 to substantially isolate the inside of housing 172 from the external environment.

Subcontroller 170 may include a plurality electrical connections, for example, be connectorized, as needed. Housing 172 may include cable connectors 190, 191, and 192. For example, connector 190 may be a Turck RKF 57 5-pin, female cable connector adapted to engage a network, for example, a DeviceNet network, connector 191 may be a Turck RKFL 46, 4-pin, cable connector, and connector 192 may be a Turck FKFDL 4.4 cable connector, or their equivalents. Connector 190 may typically be adapted to introduce DeviceNet control and/or data signals from a tool (for example, from tool 42) to subcontroller 170. Connector 190 may typically be adapted to introduce auxiliary power signals (for example, from controller 46) to subcontroller 170. Connector 192 may typically be adapted to provide communication between a tool or a tool stand and subcontroller 170.

As shown in FIG. 7, connectors 190 and 191 may be mounted to housing 172 by means of mounting plate 194 and connector 196, connector 198, and locknuts 200. Mounting plate 194 may be made of a plastic, for example, a POM plastic, such as, Dupont's Delrin® POM, or its equivalent. Connector 196 may be a multi-pin connector, for example, a male, 5-socket, RKF 57 connector, or its equivalent. Connector 198 may also be a multi-pin connector, for example, a 4-socket RKFL 46 connector, or its equivalent. Mounting plate 194 may typically be mounted over opening 195 in housing 172 by means of a plurality of fasteners 204, such as, alloy steel pan head thread-forming screws. A gasket or an O-ring seal 202, for example, a rubber O-ring, may be provided about mounting plate 194.

Connector 192 may typically be adapted to interface subcontroller 170 with a network, for example, an Ethernet network, for instance, networked with controller 46 or with external receiver 80. It will be understood by those of skill in the art that the type of network and the network configuration used with subcontroller 170 may vary broadly, for example, depending upon the type of robot used, the type of application, for example, the type of manufacturing, the wiring, and the network hardware and software, among other things. Accordingly, it will be understood that the type and attributes of connector 192 may also vary.

Subcontroller 170 may also include a plurality of spring pin assemblies 206 adapted to provide robot side to tool side signal exchange, for example, between tool-side module 170 and robot-side module 70, for example by interfacing with spring-pin assembly 106 shown in FIG. 5. Spring pin assemblies 206 include spring pin probes 208 and spring pin receptacles 210 adapted to receive spring pin probes 208. Though not shown in FIG. 7, subcontroller 170 may include at least one second set of spring pin assemblies, as needed.

According to aspects of the invention, tool-side module 170 may include one or more power supplies or energy storage devices 143, for example, the power source 43 described above, for instance, a “super capacitor,” as described above. Power supply 143 may provide at least some power to module 170, to at least temporarily power one or more devices in module 170, for example, when module tool-side component 61, 161 is disengaged from robot-side component 50, 150 of tool changer 32.

Returning to FIG. 2, in another aspect of the invention, system 30 may include a means for detecting and transmitting data, for example, operational data, from the tool-side component 52 of actuator 32, for example, under the control of subcontroller 60, to an external receiver 80, for example, to a data acquisition device or a server, for instance, for transmission or display over the Internet. The communication between actuator 32 and external receiver 80 is depicted by dash line connection 82 in FIG. 1. Connection 82 may be wired or wireless, for example, effected telemetrically. In one aspect of the invention, connection 82 may be a wired connection, for example, an Ethernet wired connection, that is, not in anyway connected to bus 48, for example, a CAN bus, though in one aspect, bus 48 may be used for connection 82.

According to aspects of the invention, various operating parameters and/or diagnostic parameters of the tool-side component 52 of actuator or tool changer 32, may be detected, stored, and/or transmitted to receiver 80 by aspects of the invention, for example, under the control of subcontroller 60 or 70. For example, operating parameters may include input status, output status, and/or power status of actuator 32 and/or tool 42. In addition, counters may be provided for couplings, uncouplings, or coupling/uncoupling cycles, for example, for the lifetime of an actuator 32 or the lifetime for a tool 42, or for a limited time limit, for example, defined by an operator. The operating parameters may include maintenance monitoring or cycle times, for example, couple-to-couple time, uncouple to uncouple timed, couple to uncouple time, uncouple to couple time, including maximum cycles times for these events. The output format on receiver 80 may take various forms, including tabular data, histograms, and time trends, for example, to diagnose potential problems or the need for maintenance, replacement, or repair.

According to aspects of the invention, receiver 80 may be a data acquisition device, a computer, or a server, for example, for transmitting operating parameters that can be viewed on an Internet web page, for example, adjacent system 30 or remote from system 30, for instance, remotely via the Internet. In one aspect, the system 30 may provide diagnostic data extraction (for example, time and date stamped) that can be viewed graphically on a web page or in .xml format to provide a time stamped log of the status of one or more parameters.

Aspects of the present invention provide tool changers, and systems and methods for controlling the operation of robotic tool changers that overcome the disadvantages of existing tool changes, systems, and methods. For example, aspects of the invention may be advantageous for high-speed robotic connections and disconnections, and for providing tool and tool changer performance information gathering. Aspects of the invention may also enhance the capability to monitor, collect, and report certain operating parameters of tool changers and tools. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A tool changer comprising:
a robot-side component mountable to a robot arm end interface;
a tool-side component adapted to engage a tool;
a first slave module associated with the robot-side component and adapted to communicate with a first master module; and
a second master module associated with the robot-side component and adapted to communicate with a second slave module associated with the tool.

2. The tool changer as recited in claim 1, wherein the first master module communicates with the first slave module by employing a first network protocol.

3. The tool changer as recited in claim 1, wherein the second master module communicates with the second slave module employing a second network protocol.

4. The tool changer as recited in claim 3, wherein the first network protocol and the second network protocol comprise a common network protocol.

5. The tool changer as recited in claim 4, wherein the common network protocol comprises DeviceNet network protocol.

6. The tool changer as recited in claim 1, wherein the second slave module further comprises a power supply.

7. The tool changer as recited in claim 6, wherein the power supply comprises a temporary power supply.

8. The tool changer as recited in claim 7, wherein the temporary power supply comprises a rechargeable temporary power supply.

9. The tool changer as recited in claim 8, wherein the rechargeable temporary power supply comprises one of a capacitor and a battery.

10. The tool changer as recited in claim 9, wherein the rechargeable temporary power supply comprises a capacitor.

11. The tool changer as recited in claim 10, wherein the capacitor comprises a super capacitor.

12. The tool changer as recited in claim 1, wherein the first slave module and the second master module are positioned in a housing mounted to the a robot-side component.

13. The tool changer as recited in claim 1, wherein the second slave module is positioned in a housing mounted to the a tool-side component.

14. The tool changer as recited in claim 1, wherein the second master module is adapted to communicate with an external receiver.

15. The tool changer as recited in claim 14, wherein the second master module is adapted to communicate with an external receiver employing a third protocol, different from the first and second network protocols.

16. The tool changer as recited in claim 15, wherein the third protocol comprises one of Ethernet protocol and Ethernet I/P protocol.

17. The tool changer as recited in claim 1, wherein the second master module is adapted to receive at least one tool operating parameter.

18. The tool changer as recited in claim 17, wherein the second master module is adapted to transmit the at least one operating parameter to the external receiver.

19. The tool changer as recited in claim 14, wherein the external receiver comprises at least one of a computer, a server, and an Internet accessible server.

20. The tool changer as recited in claim 1, wherein the tool changer comprises a robotic tool changer.

21. A system for controlling the operation of a robotic tool changer, the system comprising:
a controller having a first master module;
a robot having an arm end interface;
a tool changer having a robot-side component mounted to the arm end interface and a tool-side component adapted to engage a tool;
a first slave module associated with the robot-side component, the first slave module adapted to communicate with the first master module;
a second master module associated with the robot-side component; and
a second slave module associated with the tool-side component and adapted to communicate with the second master module.

22. The system as recited in claim 21, wherein the system further comprises a robot-side module housing mounted to the robot-side component, the robot-side module housing containing the first slave module and the second master module.

23. The system as recited in claim 21, wherein the system further comprises a tool-side module housing mounted to the tool-side component, the tool-side module housing containing the second slave module.

24. The system as recited in claim 21, wherein the first master module communicates with the first slave module by employing a first network protocol.

25. The system as recited in claim 21, wherein the second master module communicates with the second slave module employing a second network protocol.

26. The system as recited in claim 24, wherein the first network protocol and the second network protocol comprise a common network protocol.

27. The system as recited in claim 26, wherein the common network protocol comprises DeviceNet network protocol.

28. The system as recited in claim 21, wherein the second slave module comprises a power supply.

29. The system as recited in claim 28, wherein the power supply comprises a temporary power supply.

30. The system as recited in claim 30, wherein the temporary power supply comprises a rechargeable temporary power supply.

31. The system as recited in claim 30, wherein the rechargeable temporary power supply comprises one of a capacitor and a battery.

32. The system as recited in claim 30, wherein the rechargeable temporary power supply comprises a capacitor.

33. The system as recited in claim 32, wherein the capacitor comprises a super capacitor.

34. The system as recited in claim 21, wherein the second master module is adapted to communicate with an external receiver.

35. The system as recited in claim 34, wherein the second master module is adapted to communicate with an external receiver employing a third network protocol, different from the first and second network protocols.

36. The system as recited in claim 35, wherein the third protocol comprises one of Ethernet protocol and Ethernet I/P protocol.

37. The system as recited in claim 34, wherein second master module is adapted to receive at least one tool operating parameter.

38. The system as recited in claim 37, wherein the second master module is adapted to transmit the at least one operating parameter to the external receiver.

39. The system as recited in claim 34, wherein the external receiver comprises at least one of a computer, a server, and an Internet accessible server.

40. The system as recited in claim 34, wherein the at least one tool operating parameter comprises one or more of input status, output status, power status, number of couplings, number of coupling/uncoupling cycles, coupling time, and uncoupling time.

41. A method for monitoring the operation of a robot tool changer mounted to a robot, the tool changer having a robot-side component and a tool-side component, and the tool changer communicating to a controller via a network communications bus, the method comprising:
detecting an operational parameter of the tool changer;
transmitting the operational parameter to an external receiver over a communications bus, different from the control network communications bus.

42. The method as recited in claim 41, wherein the operational parameter of the tool changer comprises at least one of input status, output status, power status, number of couplings, number of coupling/uncoupling cycles, coupling time, and uncoupling time.

43. The method as recited in claim 42, wherein coupling time comprises one of couple to coupled time, uncouple to uncoupled time, couple to uncouple time, uncouple to couple time.

44. The method as recited in claim 41, wherein the receiver comprises one of a data acquisition device, a server, an internet, an extranet, an intranet, a computer, a server, an I/O device.

45. A system for monitoring the operation of a robot tool changer mounted to a robot, the tool changer having a robot-side component and a tool-side component, and the tool changer communicating to a controller via a network communications bus, the system comprising:
a detector adapted to detect an operational parameter of one of the tool changer and a tool;
a transmitter adapted to transmit the operational parameter; and
a communications bus, different from the control network communications bus, for transmitting the operational parameter to a receiver.

46. The system as recited in claim 45, wherein the operation parameter of the tool changer comprises at least one of input status, output status, power status, number of couplings, number of coupling/uncoupling cycles, coupling time, uncoupling time.

47. The system as recited in claim 46, wherein coupling time comprises one of couple to coupled time, uncouple to Uncoupled time, couple to uncouple time, uncouple to couple time.

48. The system as recited in claim 45, wherein the receiver comprises one of a data acquisition device, a server, an internet, an extranet, an intranet, a computer, a server, an I/O device.

49. The system as recited in claim 45, wherein the control network communications bus comprises a DeviceNet bus.

50. The system as recited in claim 45, wherein the communications bus comprises an Ethernet bus.

51. A method for controlling the operation of a robotic tool changer, the tool changer operated under the guidance of a controller having a master module and the tool changer having a robot-side component mounted to a robotic arm end and a tool-side component mounted to a tool, the robot-side component further having a slave module in communication with the controller master module and the robot-side component further having a master module in communication with a slave module associated with the tool-side, the method comprising:
communicating a first control signal from the controller master module to the robot-side component slave module;
communicating a second control signal, corresponding to the first control signal, from the robot-side component slave module to the robot-side component master module; and
communicating a third control signal, corresponding to the second control signal, from the robot-side component master module to the slave module associated with the tool.

52. The method as recited in claim 51, wherein the method further comprises, prior to communication the first control signal, engaging the robot-side component with the tool-side component.

53. The method as recited in claim 52, wherein the method further comprises energizing at least one device on the tool-side component prior to engaging the robot-side component with the tool-side component.

54. The method as recited in claim 53, wherein energizing comprises providing a power supply coupled to the at least one device to the tool-side component.

55. The method as recited in claim 54, wherein the power supply comprises a temporary power supply.

56. The method as recited in claim 55, wherein the temporary power supply comprises a rechargeable temporary power supply.

57. The method as recited in claim 56, wherein the rechargeable temporary power supply comprises one of a capacitor and a battery.

58. The method as recited in claim 57, wherein the rechargeable temporary power supply comprises a capacitor.

59. The method as recited in claim 58, wherein the capacitor comprises a super capacitor.

60. The method as recited in claim 58, wherein the method further comprises operating the tool in response to the third control signal.

61. A method for reducing the connection time between a robot-side component and the tool-side component of a robot tool changer, the method comprising:
energizing at least one device adapted to store at least some information about the tool-side component;
coupling the robot-side component with the tool-side component; and
communicating at least some data from the energized device to the robot-side component.

62. The method as recited in claim 61, wherein energizing comprises providing a power supply coupled to the at least one device to the tool-side component.

63. The method as recited in claim 61, wherein the power supply comprises a temporary power supply.

64. The method as recited in claim 63, wherein the temporary power supply comprises a rechargeable temporary power supply.

65. The method as recited in claim 64, wherein the rechargeable temporary power supply comprises one of a capacitor and a battery.

66. The method as recited in claim 64, wherein the rechargeable temporary power supply comprises a capacitor.

67. The method as recited in claim 66, wherein the capacitor comprises a super capacitor.
